(19) United States
(12) Patent Application Publication
(10) Pub. No.: US 2012/0212411 A1
(43) Pub. Date: Aug. 23, 2012

(54) CHARACTER INPUTTING DEVICE

(76) Inventor: Eui-Jin Oh, Daejeon (KR)

(21) Appl. No.: 12/092,409

(22) PCT Filed: Nov. 10, 2006
(86) PCT No.: PCT/KR06/04707

§ 371 Date: May 7, 2008

(30) Foreign Application Priority Data
Nov. 10, 2005 (KR) 10-2005-0107715

(51) Int. Cl. G06F 3/01; G09G 5/08; G06F 3/02

(52) U.S. Cl. 345/157; 345/156; 345/168

(57) ABSTRACT

A character input device includes an input unit for enabling direction movement input and direction pressing input; a movement input detector for detecting the direction movement input; a pressing input detector for detecting the direction pressing input; and a controller for extracting characters from a memory for execution, the characters corresponding to a result of detection performed by the movement input detector and the pressing input detector. The character input device enables its user to input desired characters accurately while minimizing the space necessary for character input. In addition, direction movement input and direction pressing input can be combined to input at least two phonemes through a single continuous operation, for rapid character input. Furthermore, the minimized input space requirement facilitates compactness and slimness of the product. Therefore, the character input device is applicable to various types of portable electronic appliances, including PDAs, laptop computers, and portable mobile communication terminals.

### CROSS-REFERENCES TO RELATED APPLICATIONS

This is a US national phase of International Application PCT/KR2006/004707, which was filed Nov. 10, 2006, and claims the benefit of priority of Republic of Korea patent application number 10-2005-0107715, which was filed Nov. 10, 2005. Both International Application PCT/KR2006/004707 and Republic of Korea patent application number 10-2005-0107715 are incorporated by reference herein.

### INTRODUCTION

The present discussion relates to a device for inputting characters. More particularly, the present discussion relates to a device and a method for inputting characters, in which a single input unit enables a user to execute direction movement input and direction pressing input simultaneously or successively so that a character containing at least two phonemes can be inputted quickly and correctly through a single input operation.

### BACKGROUND

Recently, information appliances have tended to be produced having progressively smaller sizes, in line with the development of software, semiconductor, and information processing technologies. In addition, a larger amount of characters are expected to be inputted via such information appliances.

However, conventional information appliances reveal many problems when characters or commands are inputted. In the case of input devices (e.g., keyboards) used for PCs or laptop computers, there exist restrictions in reducing the size of the input devices and, therefore, that of the information appliances incorporating them. In the case of touch screens used for PDAs or keypads used for portable telephones, their input operation is slow and may frequently experience erroneous input.

In order to input characters, numerals, or symbols more quickly with information appliances (e.g., PCs, laptop computers, PDAs, and portable telephones), it is desirable that one phoneme (character) can be inputted through one input operation (so-called “one-phoneme-per-stroke” input functionality). If this scheme is to be adopted by an information appliance based on the Korean alphabet system, for example, then as heretofore understood, the appliance must have at least 24 character input buttons or input keys. In the case of other languages (e.g., English or Japanese), the number of buttons or keys may vary.

As such, conventional input devices used for information appliances have input keys, to which respective characters are assigned, so that users can tap or press them so as to input the corresponding characters. However, in the case of personal portable information terminals (e.g., portable telephones) having only a small area for input keys, it is difficult to arrange at least 24 input keys that have the size of fingertips.

This has been an obstacle to making smaller keyboards. So, for example, in order to input at least 24 characters (in the case of the Korean alphabet) with portable terminals having no more than 12 buttons, at least two characters are inevitably assigned to a single button. As a result, in order to input a single character (phoneme), the same button must be operated at least two times in a slow and inconvenient manner.

In order to address these problems, it has been proposed to input characters based on a combination scheme (e.g., the “Chun-ji-in” scheme). However, this approach cannot solve the problem of having to operate buttons repeatedly.

There are also keyboards which can be carried while being rolled. Furthermore, according to recently proposed virtual laser keyboard technology, the image of a keyboard is projected onto a flat surface and, when the user makes a gesture as if he operates the keyboard, the finger's position is detected and regarded as input.

However, these types of input devices also have problems such as having to be carried separately or to be placed on a flat surface for input operations. Therefore, they are not suitable for personal portable information terminals which need to enable input operations on the move.

### SUMMARY

Therefore, the features set forth present discussion have been made in view of the above-mentioned problems, and it is an object of the present discussion to provide a device and a method for inputting characters, wherein a single input means enables a user to execute direction movement input and direction pressing input simultaneously or successively so that a character containing at least two phonemes can be inputted quickly and correctly through a single input operation.

According to an aspect of the present discussion, there is provided a character input device including an input unit for enabling direction movement input and direction pressing input; a movement input detector for detecting the direction movement input; a pressing input detector for detecting the direction pressing input; and a controller for extracting characters from a memory for execution, the characters corresponding to a result of detection performed by the movement input detector and the pressing input detector.

The direction movement input is performed by moving the input unit in a radial direction with regard to a reference position. The direction movement input is also performed by moving the input unit in a circumferential direction with regard to the reference position. As another example, the direction movement input can be performed through multiple stages.

Movement input detectors are provided in respective radial directions outward from the reference position so that multistage input is performed by successively detecting movement of the input unit. As one example, the input unit may be adapted to move horizontally as a whole within an input radius with respect to the reference position. In accordance other examples, the input unit may include a pointing device adapted to tilt in respective radial directions away from the reference position, or may be adapted to be lifted and/or lowered vertically so that the direction movement input is performed after lifting the input unit when characters are inputted, inter alia.

The direction movement input of the input unit may be detected in a track point detection mode. Also, the character input device may further include a guide portion for guiding the input toward unit toward respective movement input detectors.

The guide portion may include linear guides for guiding the input unit along respective radial directions extending radially from the reference position.

The guide portion further may also include a circular guide for guiding the input unit so as to move in a circumferential direction. In accordance with various examples, the guide portion may include a rotation plate positioned beneath the input and rotatable about the reference position, and may also have linear guides on the rotation plate including linear grooves extending from the reference position toward respective movement input detectors, in which the guide portion can guide circumferential movement of the input unit such that the input unit and the rotation plate rotate simultaneously on an end of the linear guides after the input unit has moved in the radial directions along the linear guides.

Each linear guide may include a groove for movably receiving a lower portion of the input unit, and an end of each linear guide adjacent to the reference position may be slanted downward toward the reference position.

The guide portion may be made of an elastic material. The guide portion further may include a click unit for generating a feel of a click in case of direction movement of the input unit.

The character input device further may include at least one elastic member positioned between the input unit and the circular guide so that, when the direction movement input may be performed through multiple stages, different resisting force may be provided for each direction movement input.

The input unit may be that enables single-stage direction movement input and double-stage direction movement input, and the elastic member may include a first elastic member having a lower elastic modulus and lying adjacent to the input unit and a second elastic member having a higher elastic modulus and lying adjacent to the circular guide.

When the input unit may be detected by movement input detectors while moving in the circumferential direction and returning to the reference position, the controller executes an input command corresponding to a final detection result of detection results.

The input unit may be made of an elastic material. An anti-slip portion may be provided on an upper surface of the input unit. A reference position detector may be positioned in the reference position so as to detect presence of the input unit in the reference position. The direction pressing input may be performed by tilting the input unit in a radial direction.

The direction pressing input may be performed by selecting pressing portions positioned on top of the input unit so as to correspond to respective radial directions.

When the input unit is a pointing device, the pressing portions may be positioned on a lateral surface of the pointing device along an outer peripheral surface so as to correspond to respective radial directions. Consonant characters are inputted by the direction movement input, and vowel characters are inputted by the direction pressing input.

The direction pressing input has eight input directions, and at least one English letter selected from ‘A’, ‘I’, ‘E’, ‘O’, ‘U’, ‘W’, and ‘Y’ may be assigned to the direction pressing input. The controller may be adapted to input a consonant first when both the direction movement input and the direction pressing input are performed within a predetermined period of time so as to input the Korean alphabet.

The input unit may be adapted for central input. The central input may be performed by a central input key positioned on a central portion of the input unit while being able to move vertically and a central input key detector for detecting movement of the central input key. The central input may alternatively be performed by a pumping input detector that detects pumping input performed by moving the input unit vertically as a whole. Also, the central input may be performed through multiple stages.

Characters are inputted by the central input. The direction pressing input may, for example, include eight input directions, in which Korean vowels ‘—’ and ‘ [symbol] ’ are assigned to the central input, and remaining Korean vowels are assigned to the direction pressing input.

Input mode conversion may be performed by the central input. When the central input is performed concurrently with the direction movement input or the direction pressing input, then conversion of characters assigned to each direction movement input or direction pressing input, mode conversion, and independent input command may be executed.

The direction pressing input may have four input directions, in which a set of English letters organized as one singlet and three pairs (for example, the letter ‘A’ by itself, in addition to the letters ‘E, I’ as one of the pairs, ‘W, Y’ as another, and ‘O, U’ as yet another) are assigned to respective input directions, four pairs of Korean letters (for example, the graphemes ‘ [symbol] , [symbol] ’ as one of the pairs, ‘ [symbol] , [symbol] ’ as another, ‘ [symbol] , [symbol] ’ as another, ‘ [symbol] , [symbol] ’ as another, and ‘—, [symbol] ’ as yet another) are assigned to respective input directions, and, when the direction pressing input may be performed concurrently with the central input, conversion from a character to a different character occurs for input.

An input set of numerals or symbols may be inputted by one of multistage direction movement inputs or by one of the direction pressing input and the central input.

The character input device may further include a case for containing the input unit, the movement input detector, the pressing input detector, and the controller, the case having at least one conversion key for converting a mode of characters (symbols, numerals, characters in a narrow sense) inputted by the input unit.

The case has at least one function key for executing one of an ENTER key function, a CANCEL key function, a cursor movement function, a SPACE key function, a SHIFT key function, a CONTROL key function, and a character combination function during data input.

The character input device may further include a display unit for displaying characters extracted by the controller. The display unit may be adapted to display an input content or a selected character mode through an input window according to an input operation of a user.

The input unit may be adapted for a mouse function, and or for a joystick function in a game mode. The movement input detector or the pressing input detector may be distributed over an entire input radius of the input unit.

A rotation wheel may be positioned on an outer side of the input unit so as to execute a scroll, volume control, or search function according to an input condition. The input unit may protrude so as to enable direction movement and direction pressing input. A number of pressing switches may be formed on a lateral surface of the input unit. The input unit itself may be adapted to rotate, and may include two input portions having identical or different character arrangement.

According to an example aspect of the present discussion, there may be provided an input device including an input unit for enabling direction movement input performed by moving the input unit in respective radial directions with regard to a reference position and direction pressing input performed by tilting the input unit in the respective radial directions; a movement input detector for detecting the direction movement input; a pressing input detector for detecting the direction pressing input; and a controller for extracting characters assigned to respective radial directions from a memory and inputting the characters based on a result of detection performed by the movement input detector and the pressing input detector.

According to another example aspect, there may be provided an input device including an input unit for performing direction movement input by moving in respective radial directions with regard to a reference position; pressing portions positioned on top of the input unit while corresponding to respective radial directions so as to perform direction pressing input; a movement input detector for detecting the direction movement input; a pressing input detector for detecting the direction pressing input; and a controller for extracting characters assigned to respective radial directions from a memory and inputting the characters based on a result of detection performed by the movement input detector and the pressing input detector.

The input device further may include a central input key positioned on a central portion of the input unit while being able to move vertically and a central input key detector for detecting movement of the central input key.

The direction movement input may be also performed by moving the input unit in a circumferential direction with regard to the reference position. Movement input detectors may be arranged in respective radial directions from the reference position so as to successively detect movement of the input unit and perform multistage input.

The input device further may include a case on which the input unit may be mounted, and two input unit may be provided on the left and right sides of the case. Consonant characters may be inputted by the direction movement input, and vowel characters may be inputted by the direction pressing input. The input unit may be adapted to attach to and detach from the display unit. The movement input detector may be positioned on a lateral surface of the circular guide.

### BRIEF DESCRIPTION OF THE DRAWINGS

The foregoing and other objects, features and advantages will become more apparent from the following detailed description when taken in conjunction with the accompanying drawings, in which:

FIG. 1 is a perspective view of a portable terminal including a character input device;

FIG. 2 is a conceptual diagram showing the operation of a character input device;

FIG. 3 shows an example of characters arranged in each radial direction on the character input device shown in FIG. 2;

FIGS. 4 to 6 are exploded perspective views of an input unit, which is used for direction movement input, according to a first embodiment;

FIG. 7 is a sectional view of an input unit according to another embodiment;

FIG. 8 shows the operation of the input unit shown in FIG. 7 when performing direction movement input and direction pressing input;

FIG. 9 is a top view of a guide portion included in an input unit;

FIG. 10 is a perspective view showing major parts of a guide portion included in an input unit;

FIG. 11 is a perspective view magnifying a linear guide near a reference position;

FIGS. 12 to 14 are top and sectional views showing an elastic member and a support ring included in an input unit;

FIGS. 15 and 16 are sectional views of an input unit according to various embodiments, when used for direction pressing input;

FIG. 17 is a top view of a guide portion according to another embodiment;

FIG. 18 shows the operation of a guide portion according to another embodiment;

FIG. 19 is a sectional view of an input unit according to a second embodiment;

FIGS. 20 and 21 are perspective views of an input unit according to a third embodiment;

FIG. 22 is a sectional view illustrating a method for detecting direction movement input with an input unit according to the second and third embodiments;

FIG. 23 is a perspective view of an input unit having an anti-slip portion formed on its upper end according to an embodiment;

FIG. 24 shows the operation of an input unit according to an embodiment, when used for central input, together with a perspective view thereof;

FIG. 25 is a top view of an input unit having a rotation wheel positioned on its outer side;

FIG. 26 shows an example of inputting characters with two input unit;

FIG. 27 is an exploded perspective view of a character input device removably placed on the body of an appliance;

FIG. 28 is a top view of a character input device having an array of the Korean alphabet; and

FIG. 29 is a top view of a character input device having an array of the English alphabet.

### DETAILED DESCRIPTION

Reference will now be made in detail to illustrative example embodiments. For clear understanding of the present discussion, relevant terminologies will now be defined. Other technical and scientific terminologies are to be interpreted in such manner as commonly understood in the field.

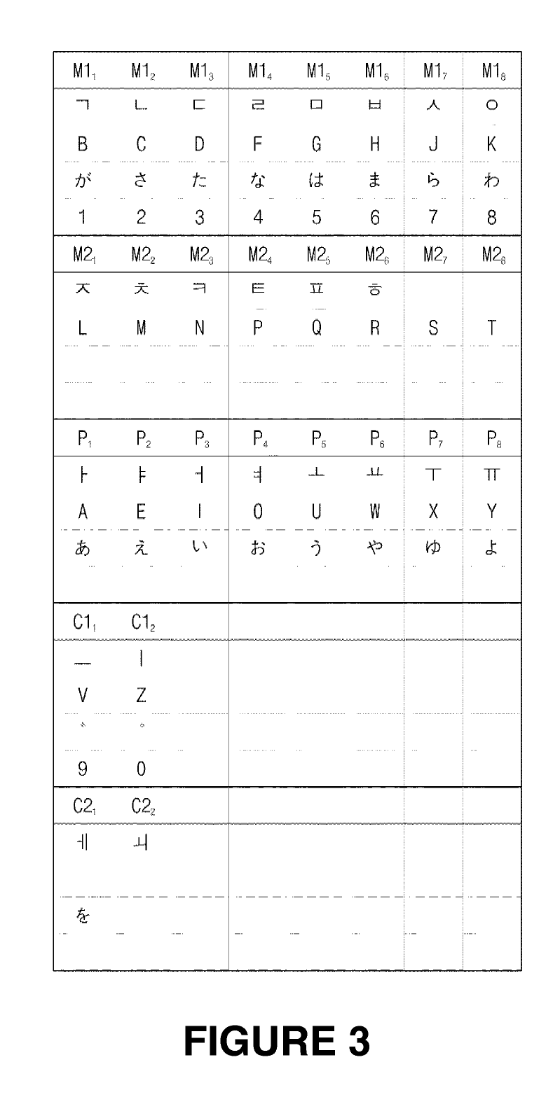

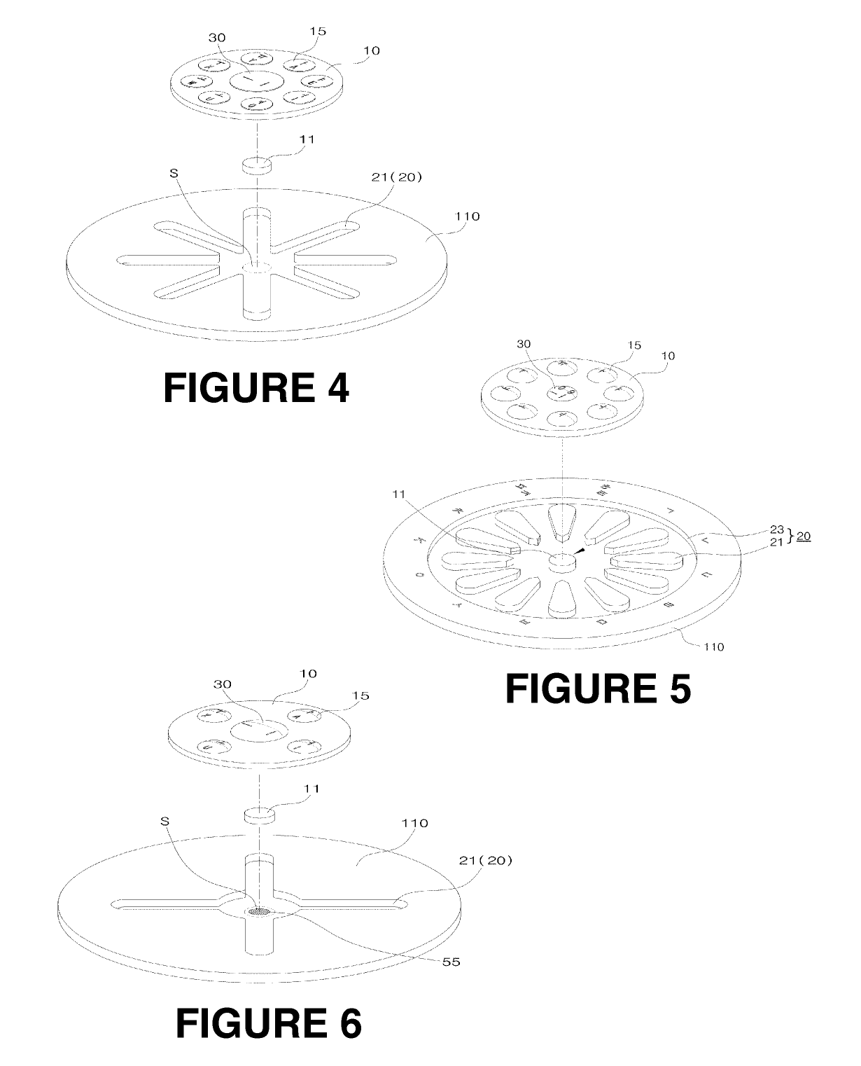

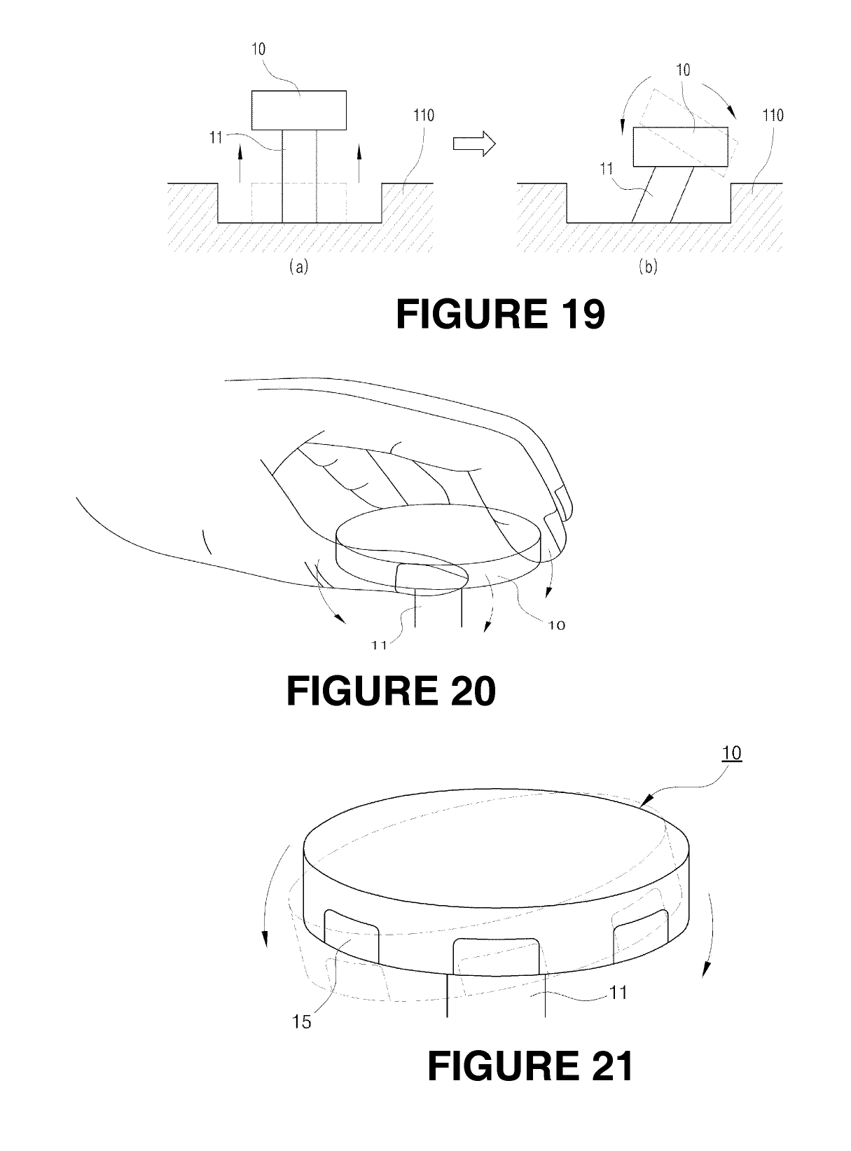

As used herein, “direction movement input” M (refer to FIG. 3) refers to the input of desired characters, numerals, or symbols by moving an input unit 10 of a character input device 1—for example, by translating (or sliding) the input unit 10 in an appropriate direction (e.g., in the horizontal direction) on the same plane (refer to FIGS. 4 to 6) or by tilting the input unit 10 at an angle or in a direction (refer to FIGS. 19 to 22).

However, the type of operation of the input unit 10 is not limited only to the particular examples set forth in the present discussion. For example, among various additional alternatives, the input unit 10 may be made of an elastic (flexible) material, and a unit for detecting very small play of the input unit 10 may be provided separately. In that case, although the input unit 10 may not necessarily be translated by horizontal or vertical force, nonetheless the effect on the controller is the same as when the input unit 10 is translated.

The input unit 10 may be replaced with an alternative component for detecting the movement or play of fingers and generating a corresponding signal. As such, the operation and construction of the input unit 10 for enabling the direction movement input M are not limited in any manner, and any kind of operation is acceptable, as long as it can inform the controller of the character input device that corresponding input has been performed, such as pushing (or applying force to) the input unit in a horizontal direction or in a transverse (approximately horizontal) direction.

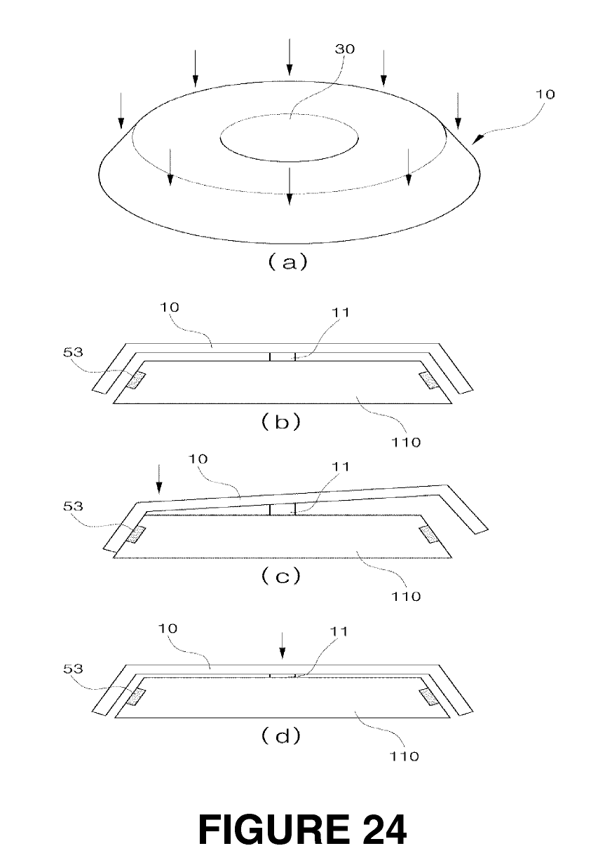

As used herein, “direction pressing input” P refers to input of desired characters, numerals, or symbols by entirely or partially tilting the input unit 10 at an angle or in a direction (refer to FIG. 24) or by selecting a pressing portion 15 (refer to FIGS. 4 to 6), which is arranged on top of the input unit 10 in each direction. Also as used herein, “central input” C includes selection of a central input key 30 (refer to FIG. 4) positioned on one side of the input unit 10 and pumping input performed by lifting/lowering the entire input unit 10 (refer to (d) of FIG. 24).

The input via the central input key 30 and the pumping input may be performed separately or in combination.

As used herein, “vowels” refer to those represented by corresponding letters in a specific language or, in the case of a language having two types of letters, those represented by one type of letters having a smaller number than the other type.

FIG. 3 shows an example of Korean, English, and Japanese vowels which can be inputted through the direction pressing input P.

As used herein, “characters” refer not only to characters, letters or graphemes used in various languages (e.g., Korean, English, or Japanese) in a narrower sense, but also to numerals and symbols.

Preferred embodiments of the present discussion will now be described in detail with reference to the accompanying drawings.

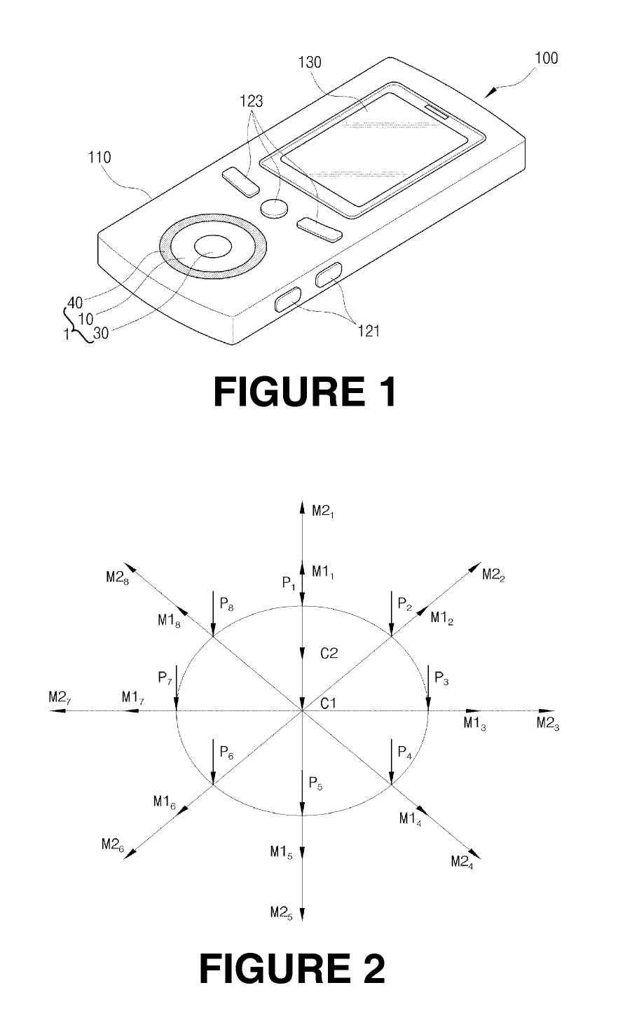

FIG. 1 is a perspective view of a portable terminal 100 including a character input device 1 according to the present discussion, and FIGS. 4 to 6 are exploded perspective views of an input unit 10 according to a first.

Referring to the drawings, the character input device 1 according to the present discussion includes an input unit 10 that enables that enables direction movement input M1 and M2 (refer to FIG. 2) and direction pressing input P; a movement input detector 51 for detecting direction movement input M; a pressing input detector 53 for detecting direction pressing input P; and a controller (not shown) for extracting a corresponding input command from a memory (not shown) based on the detection result from the movement input detector 51 and the pressing input detector 53 and executing the command.

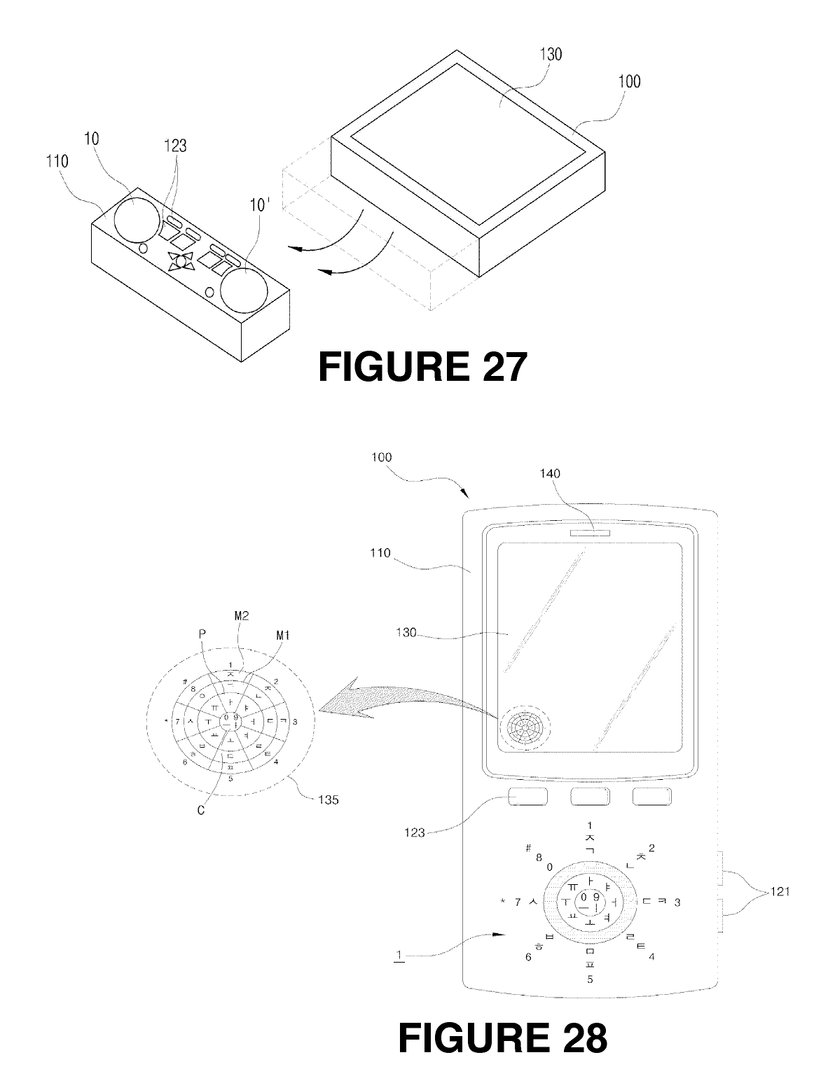

The character input device 1 may be integral with a portable mobile communication terminal 100 as shown in FIG. 1, or removably provided thereon as shown in FIG. 27. Those skilled in the art can easily understand that, in addition to the portable mobile communication terminal 100, the inventive character input device 1 is applicable to various types of electronic appliances (e.g., PDAs, laptop computers, and game machines) without limitation.

FIG. 2 is a conceptual diagram showing the operation of a character input device according to the present discussion, and FIG. 3 shows an example of characters arranged in each radial direction on the character input device shown in FIG. 2.

Referring to FIG. 2, the character input device 1 according to the present discussion accommodates direction movement input M performed by moving the input unit 10 in a radial direction with regard to a reference position S (refer to FIG. 4) and direction pressing input P performed by directing the input unit 10 in each radial direction.

The character input device 1 may also accommodate central input C performed by the input unit 10 itself.

There may be eight radial directions (refer to FIG. 4), four (refer to FIG. 5), or twelve (refer to FIG. 6).

If there are too many radial directions, the spacing between them is too small to select a desired direction correctly. In contrast, if there are too few radial directions, the number of characters assigned to respective directions decreases.

When a pair of input unit 10 are provided side by side as shown in FIG. 26, a smaller number of radial directions are necessary, because characters are distributed to both input unit 10.

The number of radial directions used for direction movement input M may be equal to or different from that of radial directions used for direction pressing input P.

The direction movement input M and central input C may be performed through at least two stages.

FIG. 3 shows an example of an array of characters and numerals, which are used in a number of languages, on a character input device 1 having eight radial directions.

In the drawing, M1 refers to single-stage direction movement input M, M2 refers to double-stage direction movement input M, P refers to direction pressing input P, C1 refers to single-stage central input C, and C2 refers to double-stage central input C. The subscript denotes each radial direction in a clockwise order.

It is clear from the drawing that consonant characters are assigned to the direction movement input M1 and M2, and vowel characters are assigned to the direction pressing input P. This is because more characters can be assigned to the direction movement input M which can be performed through multiple stages.

However, the present discussion is not limited to the above-mentioned configuration. For example, vowel characters may be assigned to the direction movement input M, and consonant characters to the direction pressing input P. Alternatively, consonant and vowel characters may be assigned to the direction movement input M and direction pressing input P in an intermingled manner.

It depends on the type of characters whether or not the direction movement input M must be performed through multiple stages.

For example, in the case of the Korean language, a total of 24 characters are necessary to represent consonants and vowels. If an input unit 10 having eight radial directions is used, single-stage direction movement input for eight characters, double-stage direction movement input for the next eight characters, and direction pressing input for the remaining eight characters are necessary.

In the case of the English language, which uses a total of 26 characters, central input for two characters needs to be added to single-stage and double-stage direction movement input for eight characters respectively and direction pressing input for the remaining eight characters.

In the case of the Japanese language, as shown in FIG. 3, all characters can be arranged without using the double-stage direction movement input M2.

It is also possible to assign a set of characters (numerals or symbols) to one of the multistage direction movement input M1 and M2 and the direction pressing input P.

Those skilled in the art can easily understand that the arrangement of characters in respective radial directions is not limited to the illustrated example, and may be modified variously according to the characteristics of characters used in the relevant language.

FIGS. 4 to 6 show input unit 10 for direction movement input M according to various embodiments of the present discussion.

An input unit 10 according to a first embodiment is configured in such a manner that the entire input unit 10 moves horizontally or slides within an input radius with regard to a reference position S.

The input unit 10 may be shaped like a plate in various manners. For example, the input unit 10 may have the shape of a circular plate as shown in FIG. 4, or that of a polygonal plate.

The input unit 10 may be made of various materials, including an elastic material.

As such, the character input device 1 according to the first embodiment is advantageous in that, since the input unit 10 can maintain a small distance from the movement input detector 51 without moving in the direction of the plate surface, the character input device 1 can be slim and compact.

The input unit 10 has pressing portions 15 positioned on its upper surface so as to enable direction pressing input P in eight radial directions.

Each pressing portion 15 carries a character assigned to the corresponding radial direction.

When at least two characters are assigned to each pressing portion 15, a conversion key 123 (refer to FIG. 1) or a function key 121, which is positioned on one side of the case 110, is selected to switch between the characters. It is also possible to switch between characters through an operation performed in combination with the central input key 30.

There are additional function keys 121 for executing corresponding functions, including an ENTER key, a CANCEL key, a cursor movement key, a SPACE key, a SHIFT key, a CONTROL key, a character combination key, and a character conversion key.

Pressing input detectors 53 are positioned beneath the pressing portions 15 so as to detect the selection of the pressing portions 15. The type of the pressing input detectors 53 depends on that of the pressing portions 15. For example, various types of switches, contact terminals, contact sensors, or pressure sensors may be used to detect the contact of the pressing portions 15. Alternatively, optical sensors may be used to detect the movement of the pressing portions 15.

The input unit 10 has a central input key 30 positioned at its center so as to enable central input C. The central input key 30 preferably exhibits a predetermined degree of repulsion so that it is not operated unintentionally when the pressing portions 15 are selected or when the input unit 10 is moved, i.e., so that input is performed only when the user operates the central input key 30 with a predetermined amount of force.

The central input C is used to input an assigned character or to execute a predetermined function (e.g., ENTER key function, SPACE key function, CANCEL key function, comma key function, or telephone call termination function). The central input C may also be used in combination with the direction movement input M and the direction pressing input P.

For example, when the Korean alphabet is to be inputted, character “—”, among characters assigned to the central input key 30, is inputted by selecting the central input key 30, and “ [symbol] ” is inputted through pumping input (refer to FIG. 24(d)). When the central input key 30 and the pressing portions 15 are pressed simultaneously, the input mode switches from Korean to English or vice versa.

The combination between the central input C and a different type of input will now be described in more detail. It is assumed that four pairs of Korean letters ( [symbol] , [symbol] ), ( [symbol] , [symbol] ), ( [symbol] , [symbol] ), and ( [symbol] , [symbol] ) are assigned to respective pressing portions 15 shown in FIG. 5. If the central input C and a pressing portion 15 corresponding to ( [symbol] , [symbol] ), are selected simultaneously, the input switches from “ [symbol] ” to “ [symbol] ” or vice versa.

Similarly, assuming that “A”, “E, I”, “W, Y”, and “O, U” are assigned to respective pressing portions 15, if the central input C and a pressing portion 15 corresponding to “E, I” are selected simultaneously, the input switches from “E” to “I” or vice versa.

Examples of usage of the central input C can be summarized as follows: when the central input is used alone, (1) the central input key 30 or the pumping input has a character assigned thereto so that it is used to input the character; (2) it is used as an input mode selection window for switching between input modes, or used to switch to a desired input mode; (3) it is used to input at least one of ENTER, SPACE, CANCEL, SHIFT, and CONTROL key functions; or (4) it is used as a speech key or a termination key when the portable mobile communication terminal 100 is in a speech mode. When the direction movement input or the direction pressing input mode is used in combination with the central input key 30 or the pumping input so as to generate two input signals simultaneously, (1) it is used to switch between characters assigned to each direction input; (2) it is used to input characters or F-keys (F1-F12), or to switch between modes (e.g., movie channel mode, music mode); or (3) it is used to execute a corresponding function (e.g., ENTER, SPACE, CANCEL, and cursor movement key functions).

The input unit 10 has a support portion 11 placed beneath it so as to support the input unit 10 in such a manner that it can move with regard to the case 110. The support portion 11 may has a cylindrical shape as shown in FIG. 4, or a ball shape. The case 110 may be provided with a guide portion 20 for guiding the support portion 11 so that the input unit 10 can be moved in a desired radial direction. The guide portion 20 may include eight linear guides 21 as shown in FIG. 3a, for example, so that the input unit 10 is guided in one of eight directions.

FIG. 5 shows an input unit 10 having four radial directions and a corresponding guide portion 20. A reference position detector 55 may be placed in the reference position S so as to detect the presence of the input unit 10, more particularly the support portion 11, in the reference position S. The reference position detector 55 detects departure of the support portion 11 from the reference position S or return to it so that the controller can select an effective signal from detection signals created until then. Signals based on detection by the reference position detector 55 may be used as reset signals for signal processing.

FIG. 6 shows an input unit 10 for enabling twelve types of direction movement input M. The input unit 10 is guided in each radial direction through the space between the linear guides 21. A circular guide 23 is positioned near an end of the linear guides 21 so that the input unit 10 is guided not only in the radial direction, but also in the circumferential direction.

In the case of “consonant+vowel+consonant” input, direction movement input M for a movement in the radial direction and direction pressing input P are performed simultaneously, and are followed by a movement in the circumferential direction for direction movement input M one more. In the case of “consonant+consonant” input, direction movement input M may be performed twice in a radial direction leading to the consonants. It is also possible to perform first direction movement input M and, after returning to the reference position S in the circumferential direction, perform second direction movement input M.

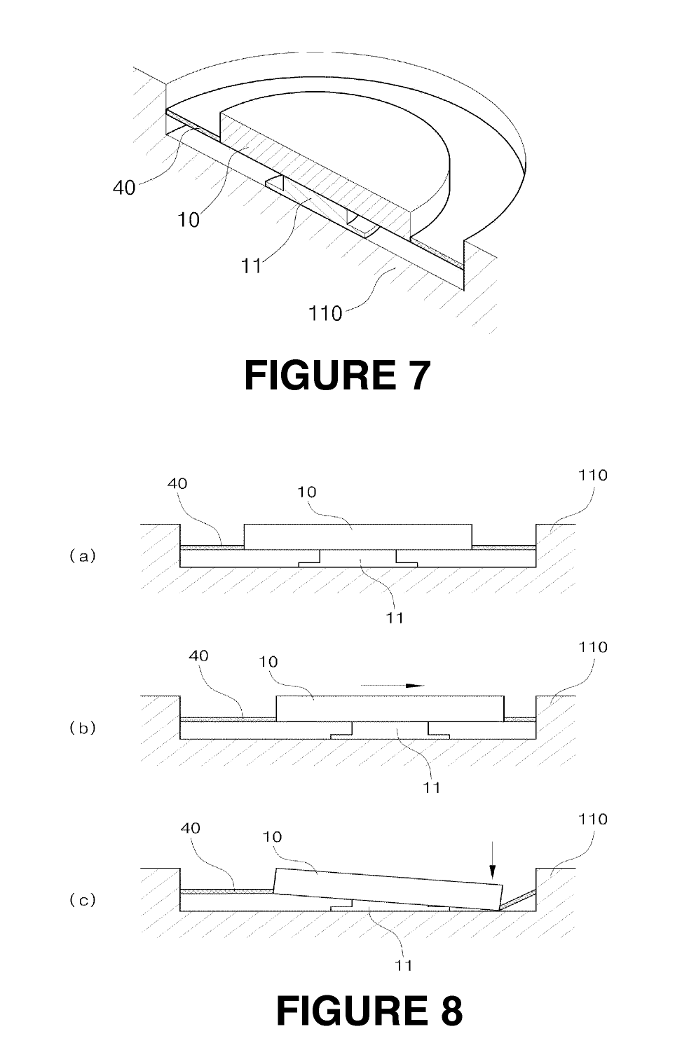

FIGS. 7 and 8 show an input unit 10 that enables direction movement input M by moving it horizontally, as well as direction pressing input P by tilting its upper end. Referring to the drawings, a support portion 11 is positioned between the case 110 and the input unit 10, and an elastic member 40 is positioned between the periphery of the input unit 10 and the case 110.

When the input unit 10 departs from the reference position S for direction movement input M, as shown in FIG. 8, the elastic member 40 applies elastic force to the input unit 10 toward the reference position S. The input unit 10 may tilt in a predetermined radial direction so as to perform direction movement input M, as shown in (c) of FIG. 8.

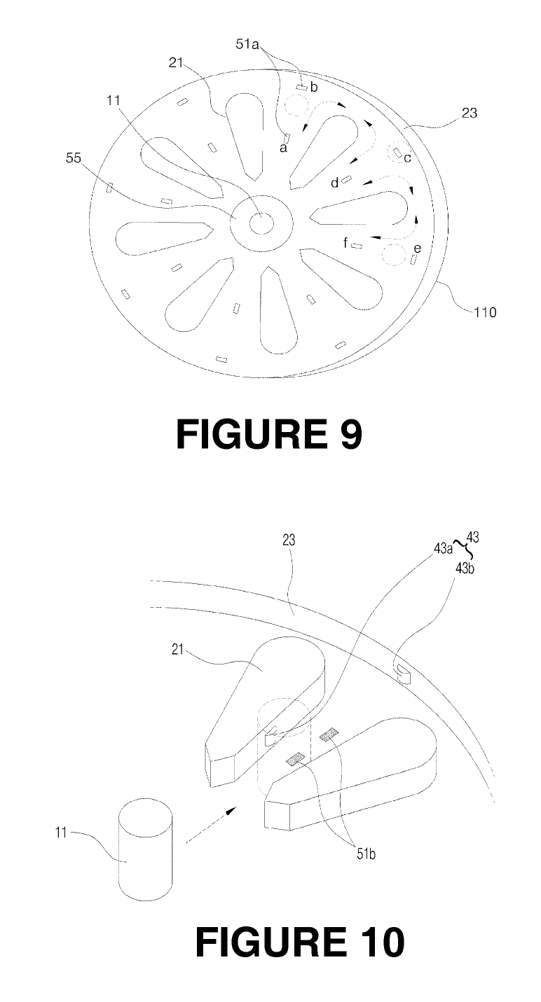

FIG. 9 is a top view of the linear guides 21 and the circular guide 23 shown in FIG. 6. Referring to the drawing, movement input detectors 51a are placed between the linear guides 21 in respective radial directions so as to detect the movement of the support portion 11 in the radial directions and transmit corresponding detection signals to the controller.

The controller determines which movement input detector 51a has detected the movement of the support portion 11, extracts corresponding text data from the memory, and inputs it. When the input unit 10 is movable along the circumferential direction as well as in the radial directions, single direction movement input M may generate a number of detection signals. In this case, the controller may select an effective signal from the detection signals according to a predetermined condition.

With reference to FIG. 9, as an example, the input unit 10 moves from the reference position S along path a→b→c→e→f while being detected by the movement input detectors 51a successively, and returns to the reference position S. Then, the controller may validate nothing but the last detection signal i.e., (i.e., the detection signal generated just before the input unit 10 returns to the reference position S) and input it. The movement input detectors 51a may be placed only along the circular guide 23. In this case, the movement input detectors 51a detect the distance of circumferential movement of the input unit 10 and enable corresponding direction movement input M.

As one example, characters may be inputted according to the rotational angle of the input unit 10 after it has contacted the circular guide 23. Alternatively, when the input unit 10 is detected by a number of movement input detectors 51 while moving along the circular guide 23, a character corresponding to the last detection signal may be inputted.

The guide portion 20 may be provided with an elastic member 40. Also, the movement input detectors may be placed on the lateral surface of the circular guide. When the movement input detectors are positioned on the lower end of the input unit, they are supposed to lie on top of a PCB, which is conventionally positioned beneath the input unit. As a result, available space on the PCB is occupied at least partially. This problem is alleviated by placing the movement input detectors on the lateral surface of the circular guide.

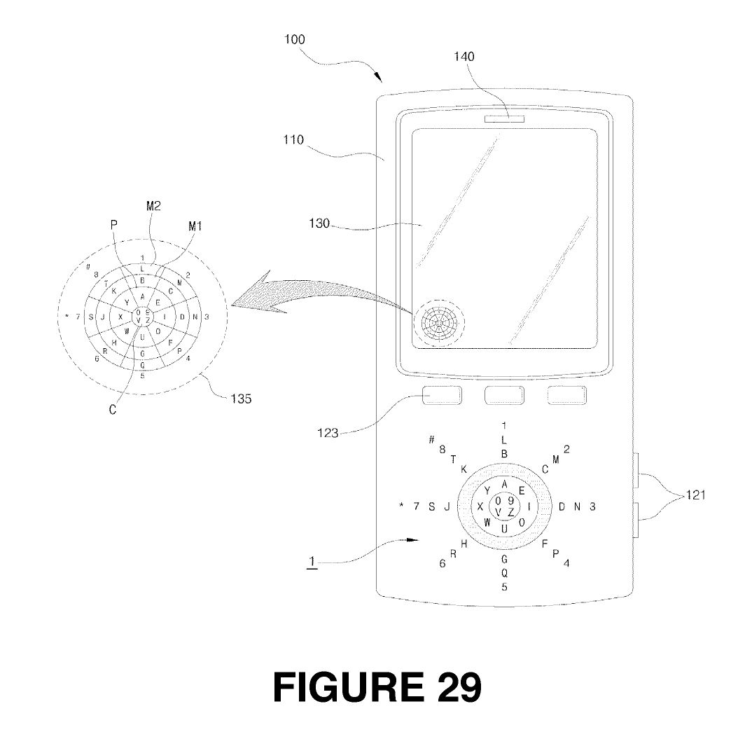

Referring to FIG. 10, at least one of the linear guides 21 and the circular guide 23 may be provided with a click unit 43 for generating a click sensation during direction movement input M. Various types of click unit 43 may be used. For example, a click unit 43a protruding from a surface of the linear guides 21 toward the movement path of the support portion 11 and those protruding similarly from a surface of the circular guide 23 may create the feel of a click when the support portion 11 passes them. It is also possible to detect the movement of the support portion 11 and audibly report it via a speaker 140 (refer to FIGS. 28 and 29).

When direction movement input M is performed through multiple stages, movement input detectors 51b may be provided in respective radial directions from the reference position S so that the movement of the input unit 10 is detected successively. For example, when double-stage direction movement input M1 and M2 is performed, two movement input detectors 51b are provided as shown in FIG. 10. If one of the movement input detectors 51b close to the reference position S detects the input unit 10, the controller regards it as single-stage input. If both movement input detectors 51b detect the input unit 10, the controller regards it as double-stage input.

Various types of movement input detectors 51 may be adopted according to respective embodiments of the present discussion, including ball mouse-type detectors, optical mouse-type detectors, optical sensors, and ultrasound sensors.

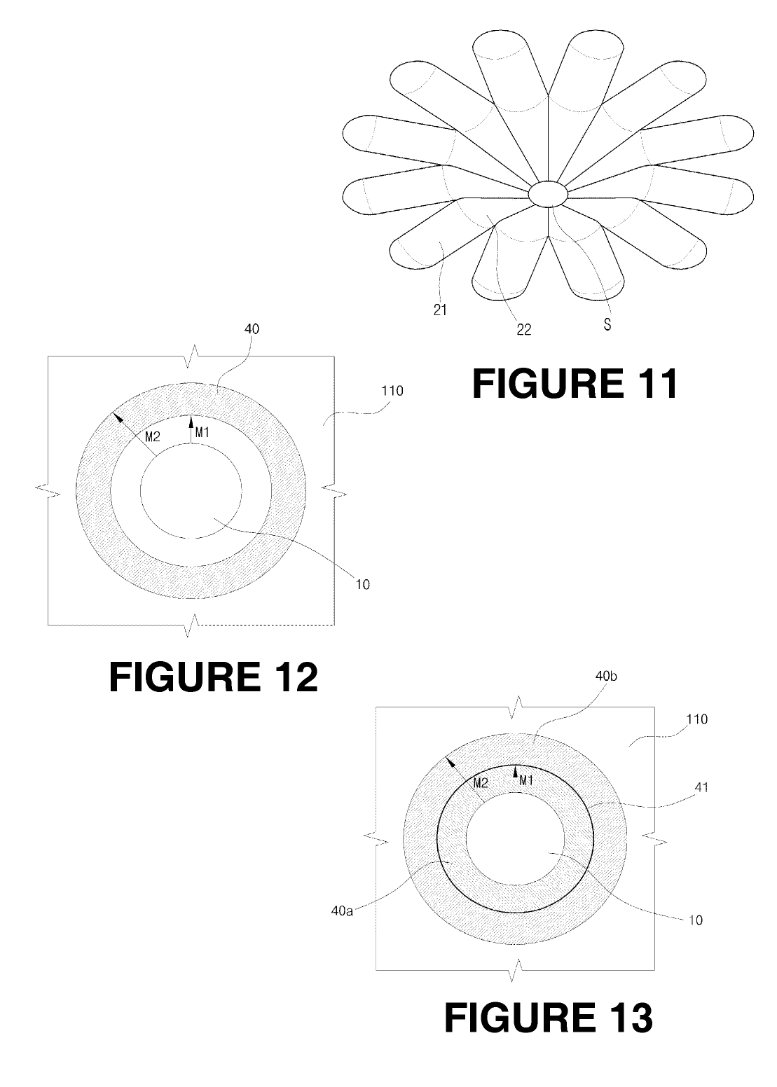

FIG. 11 shows linear guides 21 having slanted portions 22 positioned on their end near the reference position S. The slanted portions 22 are slanted downward toward the reference position S. The slanted portions 22 guide the support portion 11, when it departs from the reference position S and enters in a specific radial direction, so that it is correctly introduced in that direction. In addition, when the support portion 11 returns to the reference position S, the slanted portions 22 aid the support portion 11 to naturally locate itself in the reference position S without additional force as the support portion 11 approaches the reference position S. The slanted portions 22 also maintain the input unit 10 exactly in the reference position S.

FIGS. 12 to 14 and top and sectional views showing an elastic member 40 and a support ring 41 included in an input unit according to the present discussion. When direction movement input M is performed in multiple stages according to the traveling distance of the input unit 10, it is not easy to exactly differentiate a traveling distance corresponding to single-stage input M1 from that corresponding to double-stage input M2.

Therefore, an elastic member 40 having a predetermined elastic modulus is positioned between the input unit 10 and the case 110 as shown in FIG. 12 so that, when the input unit 10 has traveled farther than a distance corresponding to single-stage direction movement input M1, the input unit 10 receives resisting force. As a result, the user can easily differentiate single-stage direction movement input M1 from double-stage direction movement input M2.

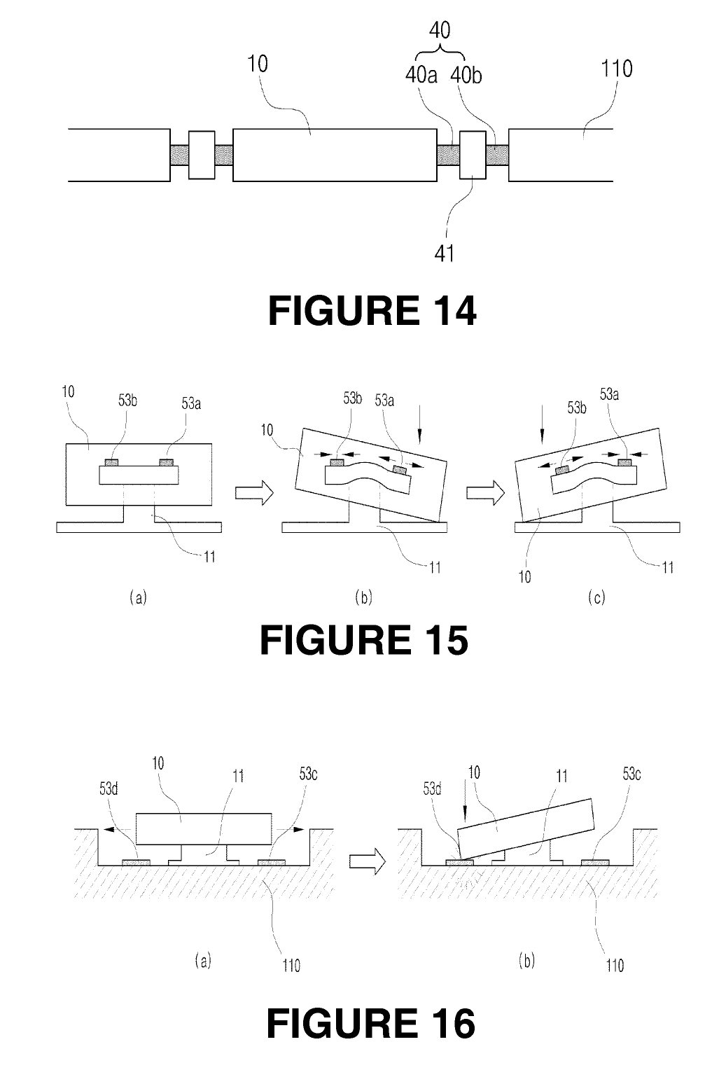

The elastic member 40 may be positioned solely on the case 110 as shown in FIG. 12. Alternatively, two elastic members 40 having different elastic moduli may be used as shown in FIGS. 13 and 14. In this case, the elastic modulus of the first elastic member 40a close to the input unit 10 is preferably lower than that of the second elastic member 40b close to the case 110. As a result, even when the first elastic member 40a is deformed by the user so as to perform single-stage direction movement input M1, the second elastic member 40b does not deform.

A support ring 41 may be placed between the first and second elastic members 40a and 40b. When the first elastic member 40a is deformed by the user, the support ring 41 prevents the resulting compression force from being concentrated on a specific part of the second elastic member 40b, which abuts the first elastic member 40a. Therefore, the second elastic member 40b does not undergo deformation. The support ring 41 also prevents direct contact between the elastic members 40a and 40b, and resulting wear. Furthermore, the elastic member 40 may be adapted to return the input unit 10 to the reference position S by unit of restoring force after direction movement input M has been performed.

FIGS. 15 and 16 show various embodiments of an input unit 10 for performing direction pressing input P according to the present discussion. According to the present discussion, direction pressing input P can be performed by tilting the input unit 10 itself in respective radial directions as shown in FIG. 15, in addition to the above-mentioned manner of using the pressing portions 15.

Pressing input detectors 53a and 53b are positioned inside the input unit 10 in respective radial directions, as shown in (a) of FIG. 15, so that, when the input unit 10 tilts in a direction, the resulting tensile force or compression force is detected. For example, tensile force is detected by a pressing input detector 53a corresponding to a direction in which direction pressing input P has been performed, and compression force is detected by another pressing input detector 53b lying in the opposite direction.

The controller may select a detection position exhibiting the greatest change from the tensile force or compression force detected by the pressing input detectors 53a and 53b so that a character assigned to that direction can be inputted. The pressing input detectors 53c and 53d may be positioned on corners of the input unit 10 or on corresponding parts of the case 110 so as to detect the contact, as shown in FIG. 16.

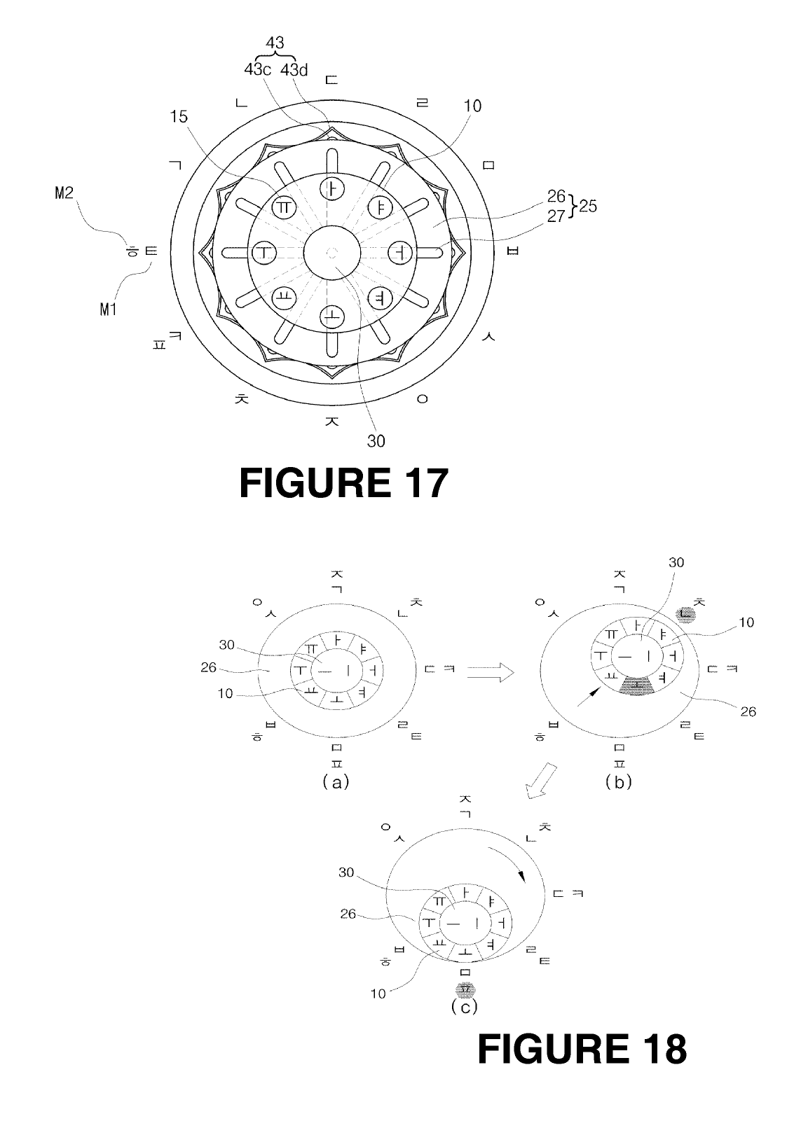

FIG. 17 is a top view of a guide portion 20 according to another example embodiment, and FIG. 18 shows the operation thereof. Referring to the drawings, the guide portion 20 may be configured as a rotation guide 25, which includes a rotation plate 26 positioned beneath the input unit 10 so as to rotate about the reference position S and linear guides 21 formed on the rotation plate 26 as linear grooves extending from the reference position S toward respective movement input detectors 51. The input unit 10 can linearly reciprocate inside the linear guides 21 and move in the circumferential direction based on rotation of the rotation plate 26.

When “ [symbol] ” is to be inputted by using the configuration shown in FIG. 18, the input unit 10 is tilted toward “ [symbol] ” and, at the same time (or after that tilting), single-stage direction movement input M1 is performed toward “ [symbol] ”. Then, the input unit 10 is rotated together with the rotation plate 26, and double-stage direction movement input M2 is performed toward “ [symbol] ”.

When consonants and vowels of the Korean language are inputted by performing direction movement input M and direction pressing input P, respectively, the controller may be configured in such a manner that, if both direction input are performed within a predetermined period of time, consonants always precede vowels. Particularly, even if the input unit 10 is tilted first (i.e., direction pressing input P is performed first) and then moved (i.e., direction movement input M is then performed), not “ [symbol] [symbol] ”, but “ [symbol] ” is inputted. However, in the case of a different language (e.g., English), such combination of consonants and vowels may be unnecessary. Therefore, input is performed in the order of detection of direction input regardless of the period.

More particularly, when an English vowel alone is to be inputted, direction pressing input P is solely performed without direction movement input M. In the case of “vowel+vowel”, direction pressing input P is performed successively with the input unit 10. In the case of “vowel+consonant” or “consonant+vowel”, direction pressing input P and direction movement input M are performed successively without the above-mentioned combination of input operations.

Referring to FIG. 17, click protrusions 43a are placed along the edge of the rotation plate 26 so as to correspond to respective radial directions, and click recesses 43b are formed on the case 110 so as to correspond to respective radial directions. When the rotation plate 26 rotates together with the input unit 10, the click recesses 43b receives/releases the click protrusions 43a and generate a feel of a click.

FIG. 19 is a sectional view of an input unit 10 according to a second embodiment. The input unit 10 according to the second embodiment is shaped like a joystick so that it tilts in respective radial directions so as to perform corresponding direction movement input M. The input unit 10 protrudes a predetermined distance from the case 110 so that the input unit 10 can move in a three-dimensional space when performing direction movement input M.

If the input unit 10 remains at a predetermined level as mentioned above, there is a possibility that it is damaged by external force, in addition to the problem in that the character input device 1 become unnecessarily bulky. Therefore, the input unit 10 may be adapted to ascend from and descend to the case 110 as shown in FIG. 19 so that it can protrude upwards only when characters are inputted. It can be easily understood by those skilled in the art that a pressing portion 15 can be placed on top of the input unit 10, and that the input unit 10 can be tilted to perform direction pressing input P (refer to (b) of FIG. 19).

When the input unit 10 according to the second embodiment is mounted on a game machine, for example, it may be used as a joystick, as well as a character input unit. In that case, the pressing portion 15 is used as a button of the joystick. The joystick function according to the present embodiment may be used similarly in the first embodiment.

FIGS. 20 and 21 are perspective views of an input unit 10 according to a third embodiment. Referring to the drawings, the input unit 10 according to the third embodiment has pressing portions 15 positioned on its periphery so that the user can grasp the input unit 10 by hand, as shown in the drawings, and perform direction movement input M (as indicated by arrows in FIG. 20) and direction pressing input P (as indicated by dotted lines in FIG. 21).

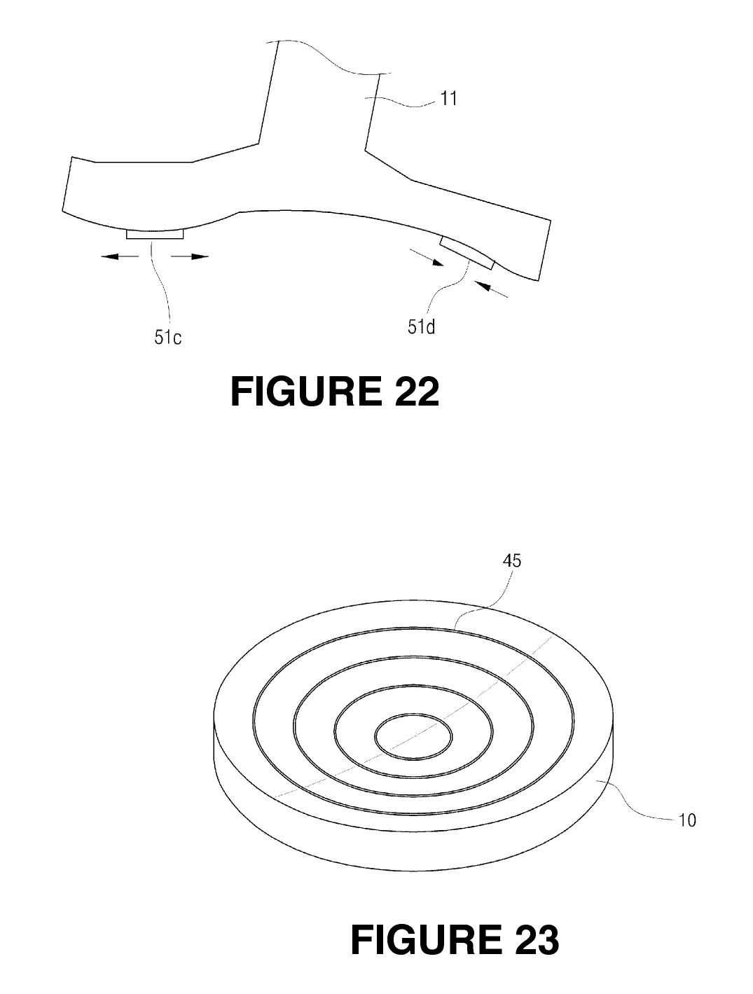

FIG. 22 is a sectional view illustrating a method for detecting direction movement input M with an input unit 10 according to the second and third embodiments of the present discussion. Referring to the drawing, when the input unit 10 has the shape of a joystick, movement input detectors 51c and 51d are arranged beneath the support portion 11 so as to correspond to respective radial directions. When direction movement input M is performed, the movement input direction is determined based on the change of pressure detected by respective movement input detectors 51c and 51d.

The movement input detectors 51c and 51d may be arranged in respective radial directions only, as shown in the drawing. Alternatively, the movement input detectors may be distributed over the entire range of input radius of the input unit 10, i.e., in a so-called touchpad or track point type.

FIG. 23 is a perspective view of an input unit 10 having an anti-slip portion 45 formed on its upper end according to an example embodiment. The anti-slip portion 45 increases the friction between the input unit 10 and fingers so as to avoid any slip between them, which may cause incorrect input. The anti-slip portion 45 may be variously configured as needed. For example, the anti-slip portion 45 may include protrusions and indentations as shown in the drawing, or a member having a large frictional coefficient may be placed on top of the input unit 10.

FIG. 24 shows the operation of an input unit 10 according to an example embodiment, when used for direction pressing input P and central input C, together with a perspective view thereof. Referring to the drawing, the input unit 10 may have the shape of an upside-down bowl. One side of the input unit 10 may be tilted to perform direction pressing input P (refer to (b) and (c) of FIG. 24), and the entire input unit 10 may be pressed to perform pumping input.

A central input key 30 may be placed at the center of the input unit 10. In this case, the input unit 10 may be configured in such a manner that, when input via the central input key 30 and pumping input are performed simultaneously, the pumping input is solely regarded as effective input. The input unit 10 may be adapted so that central input C is performed through at least two stages.

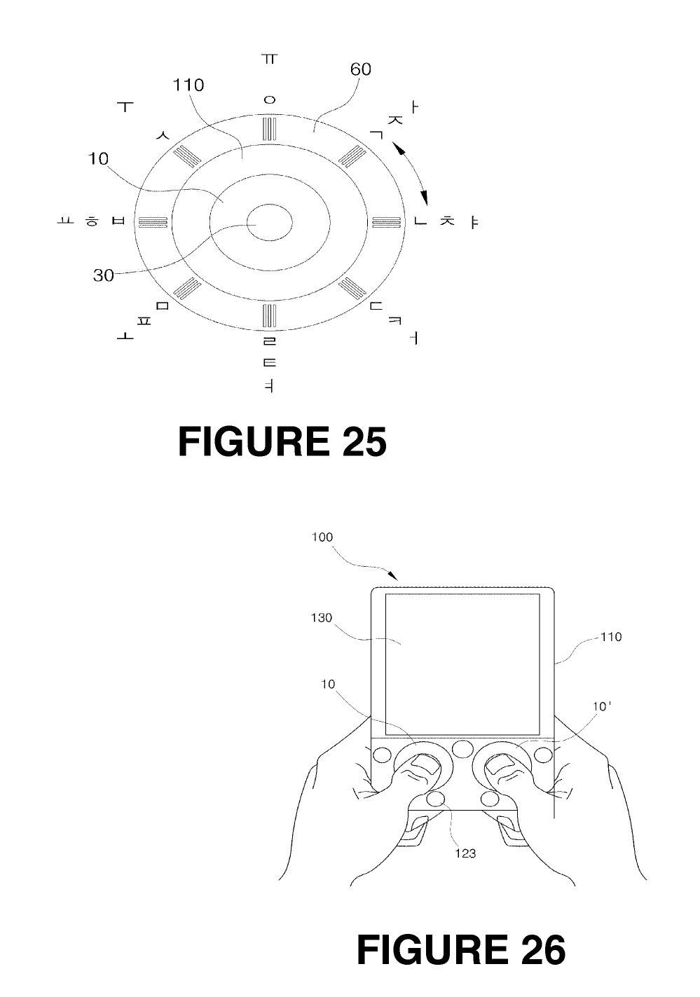

FIG. 25 is a top view of an input unit 10 having a rotation wheel 60 positioned on its outer side according to the present discussion. The rotation wheel 60 has the shape of a circular strip positioned on the outer side of the input unit 10 while being able to rotate as indicated by arrows.

The rotation wheel 60 may be adapted to incorporate the function of volume control or scroll, which is useful when the PDA or portable mobile communication terminal 100 plays music or displays messages. It is also possible to adapt the input unit 10 to be able to rotate and have the function of volume control or scroll.

Meanwhile, the movement input detectors 51 or pressing input detectors 53 of the input unit 10 according to the first embodiment may be distributed over the entire input radius in a so-called touchpad or optical sensor matrix type, instead of being arranged in a predetermined movement or pressing direction or along a movement or pressing path. This also holds in the case of the second embodiment.

The input unit according to the first and second embodiments may be used as a mouse. In this case, the position of the mouse pointer is varied by moving the input unit 10, and the mouse buttons are operated by selecting the pressing portions 15 or by tilting the input unit 10 leftward/rightward.

FIG. 26 shows an example of inputting characters with two input unit 10 according to the present discussion. As shown in the drawing, the character input device 1 according to the present discussion has two input unit 10 arranged side by side for efficient character input.

In accordance with one example, consonants may be arranged on the left input unit 10, and vowels on the right input unit 10 so that, by simplifying operations with fingers, characters can be inputted more correctly and rapidly. When consonants are divided and arranged on the left and right input unit 10, direction movement input M needs not be performed through multiple stages, because most languages have at least twelve consonants. In this case, the left and right input unit 10 have various numbers of radial directions as needed.

FIG. 27 is an exploded perspective view of a character input device 1 removably placed on the body of an appliance according to the present discussion. As such, the character input device 1 according to the present discussion can be removably connected to various appliances through a universal connector.

The input device according to the present discussion may be adapted to attach to and detach from the display unit. When the input device and the display unit are coupled or removably coupled to each other, coupling and separating devices (a coupling ring and a separating button) are provided near the contact region. The display unit has a stand positioned on its rear surface so that, when it is separated from the input device, it can be erected on the ground. Alternatively, the display unit has a ring so that it can be hung on the back of a seat (e.g., in an airplane or automobile).

The input device and the display unit may exchange signals in a wired or wireless manner or via terminal coupling when they are coupled to each other. As such, the user can separate the input device from the display unit as desired and, when in an automobile or airplane, hang the display unit on the back of the front seat. The user can now use the input device for word processing, Internet surfing, gaming, and the like.

FIGS. 28 and 29 show examples of using an input window 135 according to the present discussion with a display unit 130. Particularly, FIG. 28 shows an example of arrangement of the Korean alphabet (shown in FIG. 3) on the input window 135 and the case 110, and FIG. 29 shows an example of arrangement of the English alphabet (shown in FIG. 3) on the input window 135 and the case 110.

It can be easily understood by those skilled in the art that the arrangement of characters is not limited to that shown in FIGS. 3, 28, and 29, and may be varied according to specific requirements.

The input window 135 is placed on one side of the display unit 130 and visually displays the arrangement of characters on the input unit 10 and the case 110. Therefore, the user can be instantly aware of the current position of the input unit 10 or inputted contents via the input window 135. Furthermore, a speaker 140 may be placed on one side of the case 110 so as to create sounds corresponding to characters inputted via the input unit 10 under the control of the controller.

In general, characters or words are composed of alternating consonants and vowels, such as C+V, C+V+C, V+C, and V+C+V. For example, “run” consists of r(C)+u(V)+n(C), and “America” consists of A(V)+m(C)+e(V)+r(C)+i(V)+c(C)+a(V). The input unit according to the present discussion enables direction movement input and direction pressing input at the same time so that, when consonants are assigned to the direction movement and vowels to the direction pressing, consonants and vowels or vowels and consonants can be inputted simultaneously or successively. This enables very rapid input.

As can be seen from the foregoing, the present discussion provides a new type of character input device enabling its user to input desired characters accurately while minimizing space necessary for character input. In addition, direction movement input and direction pressing input can be combined to input at least two phonemes through a single consecutive operation. This guarantees rapid character input. Furthermore, the minimized input space facilitates compactness and slimness of the product. Therefore, the present discussion is applicable to various types of portable electronic appliances, including PDAs, laptop computers, and portable mobile communication terminals.

While this discussion has been described in connection with what is presently considered to be the most practical and preferred embodiments, it is to be understood that the invention is not limited to the particular details set forth in the above-noted illustrative embodiments and the drawings, but, on the contrary, it is intended to cover various modifications and variations within the spirit and scope of the appended claims and their equivalents.

1-69. (canceled)

70. A character input device comprising:
an input unit operable to receive direction movement input and direction pressing input;
a movement input detector configured to detect the direction movement input;
a pressing input detector configured to detect the direction pressing input; and
a controller configured to extract characters from a memory for execution, the characters corresponding to a result of detection performed by the movement input detector and the pressing input detector.

71. The character input device according to claim 70, wherein the input unit is further configured to receive direction movement input when the input unit is moved in a radial direction with respect to a reference position.

72. The character input device according to claim 71, wherein the input unit is further configured to receive direction movement input when the input unit is moved in a circumferential direction with respect to the reference position.

73. The character input device according to claim 71, wherein the input unit is further configured to receive direction movement input including multiple stages.

74. The character input device according to claim 73, further comprising a plurality of movement input detectors disposed along respective radial directions extending from the reference position so that multistage input is performed by successively detecting movement of the input unit.

75. The character input device according to claim 71, wherein the input unit is further configured to receive direction movement input when the input unit is slid.

76. The character input device according to claim 71, wherein the input unit is further configured to receive direction movement input when the input unit is tilted.

77. The character input device according to claim 76, wherein the input unit is adapted to be lifted/lowered vertically so that the direction movement input and the direction pressing input are performed after lifting the input unit.

78. The character input device according to claim 71, wherein the direction movement input of the input unit is detected in a track point detection mode.

79. The character input device according to claim 71, further comprising a guide portion configured to guide the input unit toward respective movement input detectors.

80. The character input device according to claim 79, wherein the guide portion comprises a plurality of linear guides configured to guide the input unit along respective radial directions extending from the reference position.

81. The character input device according to claim 79, wherein the guide portion further comprises a circular guide configured to guide movement of the input unit.

82. The character input device according to claim 80, wherein each linear guide includes a groove for movably receiving the input unit, and an end of each linear guide adjacent to the reference position is slanted downward toward the reference position.

83. The character input device according to claim 79, wherein the guide portion is made of an elastic material.

84. The character input device according to claim 79, wherein the guide portion further comprises a click unit configured to generate a click sensation when direction movement of the input unit occurs.

85. The character input device according to claim 81, further comprising at least one elastic member positioned between the input unit and the circular guide such that different resisting force is provided for each direction movement input when the direction movement input is performed including multiple stages.

86. The character input device according to claim 85, wherein the input unit is that enables single-stage direction movement input and double-stage direction movement input, and the elastic member comprises a first elastic member having a lower elastic modulus positioned adjacent to the input unit and a second elastic member having a higher elastic modulus positioned adjacent to the circular guide.

87. The character input device according to claim 72, wherein the controller executes an input command corresponding to a final detection result of a plurality of detection results when the input unit is detected by a plurality of movement input detectors while moving in the circumferential direction and returning to the reference position.

88. The character input device according to claim 71, wherein the input unit is made of an elastic material.

89. The character input device according to claim 71, wherein an anti-slip portion is provided on an upper surface of the input unit.

90. The character input device according to claim 71, further comprising a reference position detector positioned in the reference position and configured to detect whether the input unit is present in the reference position.

91. The character input device according to claim 71, wherein the direction pressing input is performed by tilting a top member of the input unit in a radial direction.

92. The character input device according to claim 71, wherein the direction pressing input is performed by selecting pressing portions positioned so as to correspond to respective radial directions of the input unit.

93. The character input device according to claim 92, wherein the input unit includes a pointing device, and the pressing portions are positioned on a lateral surface of the pointing device along an outer peripheral surface so as to correspond to respective radial directions.

94. The character input device according to claim 70, wherein the input unit is operable to input consonant characters based on the direction movement input, and to input vowel characters based on the direction pressing input.

95. The character input device according to claim 94, wherein the direction pressing input has eight input directions, and at least one English letter selected from the group consisting of ‘A’, ‘I’, ‘E’, ‘O’, ‘U’, ‘W’, and ‘Y’ is assigned to the direction pressing input.

96. The character input device according to claim 94, wherein the controller is adapted to first input a consonant of the Korean alphabet when both the direction movement input and the direction pressing input are performed within a predetermined period of time.

97. The character input device according to claim 71, wherein the input unit is adapted for central input.

98. The character input device according to claim 97, wherein the input unit further includes a central input key positioned on a central portion of the input unit operable to move vertically and a central input key detector configured to detect movement of the central input key, and the input unit is configured to input the central input based on the central input key and the central input key detector.

99. The character input device according to claim 97, wherein the central input is performed by a pumping input detector adapted to detect pumping input when the input unit is moved vertically as a whole.

100. The character input device according to claim 97, wherein the central input is performed including multiple stages.

101. The character input device according to claim 97, wherein input mode conversion is performed based on the central input.

102. The character input device according to claim 97, wherein an operation selected from the group consisting of conversion of characters assigned to each direction movement input or direction pressing input, mode conversion, and independent input command is executed when the central input is performed concurrently with the direction movement input or the direction pressing input.

103. The character input device according to claim 102, wherein the direction pressing input has four input directions,
wherein the English letter ‘A’ and three pairs of English letters are assigned to respective input directions, the three pairs of English letters including ‘E, I’ as a pair, ‘W, Y’ as a pair, and ‘O, U’ as a pair, and
wherein four pairs of Korean letters are assigned to respective input directions, the four pairs of Korean letters including ‘ [symbol] , [symbol] ’, ‘ [symbol] , [symbol] ’, [symbol] , [symbol] ’, [symbol] , [symbol] ’, ‘—, [symbol] ’.

104. The character input device according to claim 73, wherein an input set of numerals or symbols is inputted by one multistage direction movement input or by one direction pressing input and the central input.

105. The character input device according to claim 70, further comprising a case configured to contain the input unit, the movement input detector, the pressing input detector, and the controller, the case having at least one conversion key configured to convert a mode of characters (symbols, numerals, characters in a narrow sense) inputted by the input unit.

106. The character input device according to claim 105, wherein the case has at least one function key configured to execute an ENTER key function, a CANCEL key function, a cursor movement function, a SPACE key function, a SHIFT key function, a CONTROL key function, or a character combination function during data input.

107. The character input device according to claim 70, further comprising a display unit configured to display characters extracted by the controller.

108. The character input device according to claim 107, wherein the display unit is adapted to display an input content based on an input operation of a user or an input content based on a selected character input mode through an input window.

109. The character input device according to claim 107, wherein the input unit is adapted to attach to and detach from the display unit.

110. The character input device according to claim 71, wherein direction movement of the input unit moves a position of a pointer, and direction pressing input performs a button operation of a mouse.

111. The character input device according to claim 70, wherein the movement input detector or the pressing input detector is distributed over an entire input radius of the input unit.

112. The character input device according to claim 110, wherein a rotation wheel is positioned on an outer side of the input unit and is configured to execute a scroll, volume control, or search function according to an input condition.

113. The character input device according to claim 81, wherein the input unit protrudes so as to enable direction movement and direction pressing input.

114. The character input device according to claim 113, further comprising a plurality of pressing switches on a lateral surface of the input unit.

115. The character input device according to claim 71, wherein the input unit is adapted to rotate.

116. The character input device according to claim 70, wherein the input unit includes a first input portion and a second input portion.

117. The character input device according to claim 116, wherein consonants are arranged on the first input portion, and vowels are arranged on the second input portion.

118. The input device according to claim 71, wherein the controller is adapted to determine a detector as an input direction, the detector showing a largest change.

119. The character input device according to claim 70, wherein the input unit is adapted to automatically return to a reference position after movement.

120. The character input device according to claim 81, wherein the movement input detector is positioned on a lateral surface of the circular guide.

121. An input device comprising:
an input unit configured to enable direction movement input performed by moving the input unit in respective radial directions with respect to a reference position and direction pressing input performed by tilting a top member of the input unit in the respective radial directions
a movement input detector configured to detect the direction movement input;
a pressing input detector configured to detect the direction pressing input; and
a controller configured to extract an input command result from a memory and executing the input command result, the input command result corresponding to a result of detection performed by the movement input detector and the pressing input detector.

122. The input device according to claim 121, further comprising a central input key positioned on a central portion of the input unit and operable to move vertically and a central input key detector configured to detect movement of the central input key.

123. The input device according to claim 121, wherein the direction movement input is performable by moving the input unit in a circumferential direction with respect to the reference position.

124. The input device according to claim 121, wherein the movement input detector is adapted for multistage input.

125. The input device according to claim 121, wherein the input unit comprises left and right units.

126. The input device according to claim 121, wherein consonant characters are inputted by the direction movement input, and vowel characters are inputted by the direction pressing input.

127. The input device according to claim 121, wherein direction movement of the input unit moves a position of a pointer, and direction pressing input performs a button operation of a mouse.

128. The input device according to claim 121, wherein the input unit is adapted to perform a game operation command.

129. The input device according to claim 121, wherein the input unit is further configured to receive direction movement input when sliding the input unit in a radial direction.

130. The input device according to claim 121, wherein the input unit is further configured to receive direction movement input when tilting the input unit in a radial direction.

131. The input device according to claim 121, wherein the input unit is adapted to automatically return to the reference position after movement.

132. The input device according to claim 121, wherein the input unit has a top with an area determined so that direction pressing in respective radial directions can be performed while a finger is placed on the top, and the direction movement input by the input unit is performed by movement within a movement radius of a finger.

133. The input device according to claim 121, wherein the input unit has a top with an area determined so that direction pressing in respective radial directions can be performed within a movement radius of a finger, and the direction movement input by the input unit is performed by movement within the movement radius of a finger.

134. An input device comprising:
an input unit operable to perform direction movement input by moving the input unit along respective radial directions with respect to a reference position;
a plurality of pressing portions positioned to correspond to respective radial directions of the input unit and configured to enable direction pressing input;
a movement input detector configured to detect the direction movement input;
a pressing input detector configured to detect the direction pressing input; and
a controller configured to extract an input command result from a memory and to execute the input command result, the input command result corresponding to a result of detection performed by the movement input detector and the pressing input detector.

135. The input device according to claim 134, further comprising a central input key positioned on a central portion of the input unit and operable to move vertically and a central input key detector configured to detect movement of the central input key.

136. The input device according to claim 134, wherein the direction movement input is performable by moving the input unit in a circumferential direction with respect to the reference position.

137. The input device according to claim 134, wherein the movement input detector is adapted for multistage input.

138. The input device according to claim 134, wherein the input unit comprises left and right units.

139. The input device according to claim 134, wherein consonant characters are inputted by the direction movement input, and vowel characters are inputted by the direction pressing input.

140. The input device according to claim 134, wherein direction movement of the input unit moves a position of a pointer, and direction pressing input performs a button operation of a mouse.

141. The input device according to claim 134, wherein the input unit is adapted to perform a game operation command.

142. The input device according to claim 134, wherein the input unit is further configured to receive direction movement input when sliding the input unit in a radial direction.

143. The input device according to claim 134, wherein the input unit is further configured to receive direction movement input when tilting the input unit in a radial direction.

144. The input device according to claim 134, wherein the input unit is adapted to automatically return to the reference position after movement.

145. The input device according to claim 134, wherein the input unit has a top with an area determined so that direction pressing in respective radial directions can be performed while a finger is placed on top, and the direction movement input by the input unit is performed by movement within a movement radius of a finger.

146. The input device according to claim 134, wherein the input unit has a top with an area determined so that direction pressing in respective radial directions can be performed within a movement radius of a finger, and the direction movement input by the input unit is performed by movement within the movement radius of a finger.
